(19) United States
(12) Patent Application Publication
(10) Pub. No.: US 2026/0073590 A1
(43) Pub. Date: Mar. 12, 2026

(54) TECHNIQUES FOR SEMANTICALLY ALIGNED GENERATIVE AUGMENTATION FOR TRAINING POLICY MODELS

(71) Applicant: NVIDIA CORPORATION, Santa Clara, CA (US)

(72) Inventors: Jie XU, Bellevue, WA (US); Yashraj Shyam NARANG, Seattle, WA (US); Stanley BIRCHFIELD, Sammamish, WA (US); Dieter FOX, Seattle, WA (US); Ankur HANDA, Seattle, WA (US); Pingchuan MA, Santa Clara, CA (US); Bowen WEN, Bellevue, WA (US); Wei YANG, Lake Forest Park, WA (US)

(21) Appl. No.: 19/172,579

(22) Filed: Apr. 7, 2025

Related U.S. Application Data
(60) Provisional application No. 63/692,567, filed on Sep. 9, 2024.

(51) Int. Cl. G06T 11/60; G06T 7/50; G06V 10/771

(52) U.S. Cl. CPC G06T 11/60; G06T 7/50; G06V 10/771; G06T 2207/20081; G06V 2201/07

(57) ABSTRACT

A computer-implemented technique for training machine learning models includes processing one or more input images using a trained image generative model to generate one or more augmented images, where the trained image generative model generates each augmented image included in the one or more augmented images conditioned on an input image included in the one or more input images, depth information associated with the input image, semantic information associated with the input image, and text describing an augmentation to make to the input image; and performing, based on the one or more augmented images, one or more operations to train an untrained machine learning model to generate a trained machine learning model.

### CROSS-REFERENCE TO RELATED APPLICATIONS

This application claims priority benefit of the U.S. Provisional Patent Application titled, “DEEP GENERATIVE VISUAL AUGMENTATION FOR GENERALIZABLE ROBOTIC VISUOMOTOR SKILL LEARNING,” filed on Sep. 9, 2024, and having Ser. No. 63/692,567. The subject matter of this related application is hereby incorporated herein by reference.

### BACKGROUND

### Field of the Various Embodiments

The various embodiments relate generally to computer science, artificial intelligence (AI) and machine learning, and robot control and, more specifically, to techniques for semantically aligned generative augmentation for training policy models.

### Description of the Related Art

In machine learning, visual motor policy learning involves training a machine learning model, also referred to as a “policy” model, to generate motor actions for controlling a robot given image data as input. Once trained, the policy model can be applied to control a robot to perform a task, such as manipulating an object or navigating through an environment.

One conventional approach for visual motor policy learning trains a policy model in a real-world environment using images that are captured by cameras and demonstrations of robot actions that the policy model learns to imitate. In some cases, the policy model can also convert the real-world images into canonical images, which are simplified versions of the real-world images. Because training a policy model in a real-world environment can be time consuming and might damage a robot, an alternative approach for visual motor policy learning is to train the policy model using training data that is generated via simulations of the robot in a virtual environment.

One drawback of the above approaches, however, is that the trained policy model may fail to correctly control the physical robot to perform a task in a real-world environment when captured images of the real-world environment differ from the images used during training. For example, the captured images and the training images might differ in terms of the colors or textures of objects, the lighting conditions, or the like in those images. These differences are referred to as a “sim-to-real gap” when the training data used to train the policy model is generated via simulations and a “real-to-real gap” when the training data is generated in a real-world environment. Due to the sim-to-real or real-to-real gap, the trained policy can fail to adapt to real-world scenarios that are different from the training data and, therefore, be unable to correctly control a robot in those different scenarios.

Further, in cases where the policy model converts captured real-world images into canonical images, the canonical images oftentimes differ significantly from the captured images. For example, the canonical images could have objects at different depths than the captured images. Accurate depth information is important for a robot to avoid collisions and grasp objects, among other things. Accordingly, a trained policy model that converts captured real-world images into canonical images can fail to correctly control a robot in various scenarios.

As the foregoing illustrates, what is needed in the art are more effective techniques for training policy models to control robots to perform tasks.

### SUMMARY

One embodiment of the present disclosure sets forth a computer-implemented method for training machine learning models. The method includes processing one or more input images using a trained image generative model to generate one or more augmented images. The trained image generative model generates each augmented image included in the one or more augmented images conditioned on an input image included in the one or more input images, depth information associated with the input image, semantic information associated with the input image, and text describing an augmentation to make to the input image. The method further includes performing, based on the one or more augmented images, one or more operations to train an untrained machine learning model to generate a trained machine learning model.

At least one technical advantage of the disclosed techniques relative to the prior art is that the disclosed techniques generate augmented images that can provide diverse data sets for training machine learning models, such as policy models for controlling robots. Using augmented images generated according to the disclosed techniques, a policy model can be trained to control a robot to perform a task more successfully than policy models that are trained using conventional approaches. In particular, the augmented images preserve depth and semantic information from input images, which are useful for training a policy model to correctly perform tasks. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of at least one embodiment;

FIG. 2 is a more detailed illustration of the machine learning server of FIG. 1, according to various embodiments;

FIG. 3 is a more detailed illustration of the computing device of FIG. 1, according to various embodiments;

FIG. 4 illustrates how a policy model can be trained to control a robot, according to various embodiments;

FIG. 5 is a more detailed illustration of the image generative model of FIG. 1, according to various embodiments;

FIG. 6 illustrates exemplar input and output images of the image generative model of FIG. 1, according to various embodiments;

FIG. 7 is a flow diagram of method steps for training an image generative model, according to various embodiments; and

FIG. 8 is a flow diagram of method steps for controlling a robot, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

### General Overview

Embodiments of the present disclosure provide techniques for generating augmented image data and training machine learning models using the augmented image data. In some embodiments, a trained image generative model takes as input images and text describing augmentations, and the image generative model generates augmented images conditioned on the input images, depth and semantic features extracted from the input images, and the text describing the augmentations. The image generative model includes three diffusion modules. For a given image input image and text, a first diffusion module is used to generate a feature map conditioned on the input image and the text. A second diffusion module is used to generate a second feature map conditioned on the image, depth features extracted from the image, and the text. A third diffusion module is used to generate a third feature map conditioned on the image, semantic features extracted from the image, and the text. A decoder processes the first, second, and third feature maps to generate an augmented image. Any number of augmented images can be generated according to the foregoing steps for inclusion in a training data set. Then, a machine learning model, such as a policy model for controlling a robot, can be trained using the training data set. Once trained, the machine learning model can be deployed to perform one or more tasks. For example, a trained policy model could be deployed to control a robot within a real or virtual environment.

The techniques for generating augmented image data and training machine learning models of the present disclosure have many real-world applications. For example, these techniques can be used to generate augmented image data and train policy models to control robots in real environments or to control simulations of robots in virtual environments. As another example, these techniques can be used to generate augmented image data and train any technically feasible machine learning models that can benefit from being trained with the augmented image data.

The above examples are not in any way intended to be limiting. As persons skilled in the art will appreciate, as a general matter, the techniques for generating augmented image data and training machine learning models that are described herein can be implemented in any application where trained machine learning models are required or useful.

### System Overview

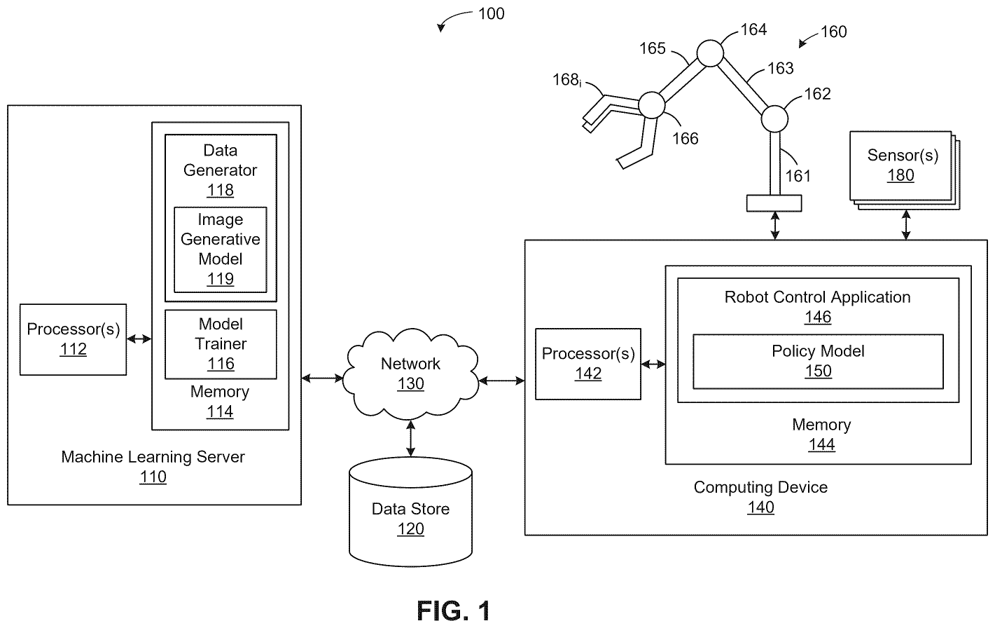

FIG. 1 illustrates a block diagram of a computer-based system 100 configured to implement one or more aspects of at least one embodiment. As shown, the system 100 includes, without limitation, a machine learning server 110, a data store 120, and a computing device 140 in communication over a network 130, which can include a wide area network (WAN) such as the Internet, a local area network (LAN), a cellular network, and/or any other suitable network or networks.

As shown, a model trainer 116 and an image generative model 119 execute on one or more processors 112 of the machine learning server 110 and are stored in a system memory 114 of the machine learning server 110. The processor(s) 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor(s) 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

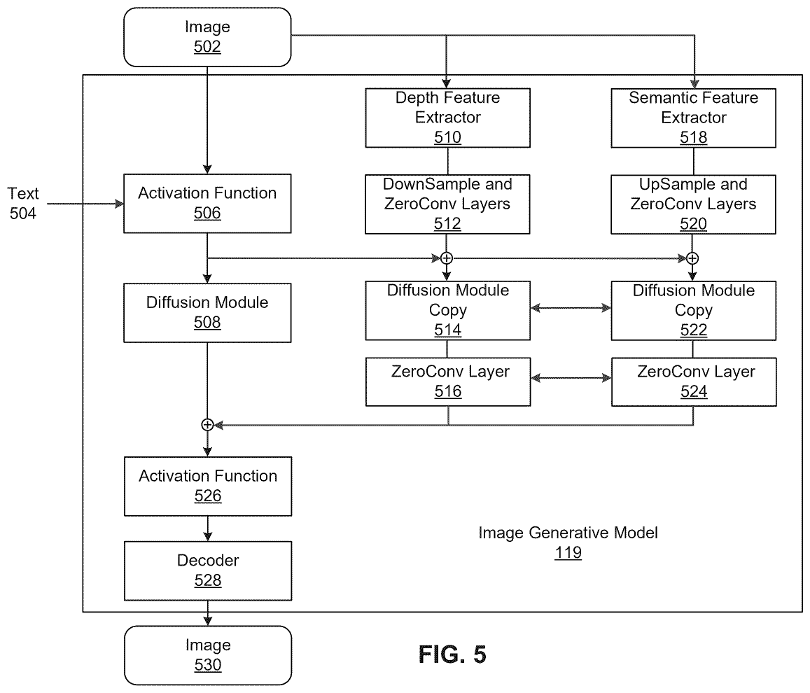

In some embodiments, the model trainer 116 is configured to train one or more machine learning models, including an image generative model 119 that is trained to generate augmented images for training a policy model 150, which is trained to control a robot to perform a task. The image generative model 119 and the policy model 150 can be trained in any technically feasible manner by the model trainer 116, or by different model trainers. Details of the image generative model 119 and the policy model 150, as well as techniques for training the same, are discussed in greater detail below in conjunction with FIGS. 5 and 7-8. Training data and/or trained machine learning models, including the image generative model 119 and the policy model 150, can be stored in the data store 120 or elsewhere. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

As shown, the data generator 118 that uses the image generative model 119 is stored in the system memory 114, and executes on the processor(s) 112, of the machine learning server 110. Once trained, the image generative model 119 can be deployed in any suitable manner, such as in the data generator 118, for use in generating augmented images.

As shown, a robot control application 146 that uses the trained policy model 150 is stored in a system memory 144, and executes on processor(s) 142, of the computing device 140. Once trained, the policy model 150 can be deployed in any suitable manner, such as in the robot control application 146. Illustratively, given sensor data captured by one or more sensors 180, such as images captured by one or more cameras, the policy model 150 can be used to control a physical robot 160 to perform a task, for which the policy model 150 was trained, in a real-world environment.

As shown, the robot 160 includes multiple links 161, 163, and 165 that are rigid members, as well as joints 162, 164, and 166 that are movable components that can be actuated to cause relative motion between adjacent links. In addition, the robot 160 includes multiple fingers 168i (referred to herein collectively as fingers 168 and individually as a finger 168) that can be controlled to grip an object. Although an example robot 160 is shown for illustrative purposes, in some embodiments, techniques disclosed herein can be applied to control any suitable robot.

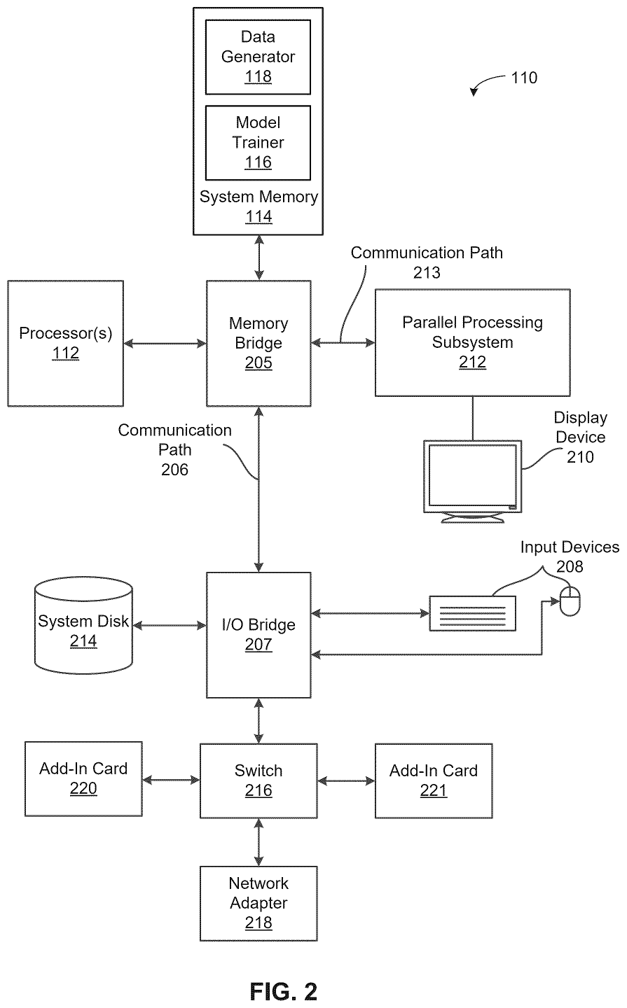

FIG. 2 is a more detailed illustration of the machine learning server 110 of FIG. 1, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In various embodiments, the machine learning server 110 includes, without limitation, the processor(s) 112 and the system memory 114 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 may be a server machine in a cloud computing environment. In such embodiments, the machine learning server 110 may not include input devices 208, but may receive equivalent input information by receiving commands (e.g., responsive to one or more inputs from a remote computing device) in the form of messages transmitted over a network and received via the network adapter 218. In some embodiments, the switch 216 is configured to provide connections between the I/O bridge 207 and other components of the machine learning server 110, such as a network adapter 218 and various add-in cards 220 and 221.

In some embodiments, the I/O bridge 207 is coupled to a system disk 214 that may be configured to store content and applications and data for use by processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, the communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the model trainer 116 and the data generator 118. Although described herein primarily with respect to the model trainer 116 and the data generator 118, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system. For example, the parallel processing subsystem 212 may be integrated with the processor(s) 112 and other connection circuitry on a single chip to form a system on a chip (SoC).

In some embodiments, the processor(s) 112 includes the primary processor of machine learning server 110, controlling and coordinating operations of other system components. In some embodiments, the processor(s) 112 issue commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, the system memory 114 could be connected to the processor(s) 112 directly rather than through the memory bridge 205, and other devices may communicate with the system memory 114 via the memory bridge 205 and the processor(s) 112. In other embodiments, the parallel processing subsystem 212 may be connected to the I/O bridge 207 or directly to the processor(s) 112, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. For example, the parallel processing subsystem 212 may be implemented as a virtualized parallel processing subsystem in at least one embodiment. As a specific example, the parallel processing subsystem 212 may be implemented as virtual graphics processing unit(s) (vGPU(s)) that render graphics on a virtual machine(s) (VM(s)) executing on server machine(s) whose GPU(s) and other physical resources are shared across one or more VMs.

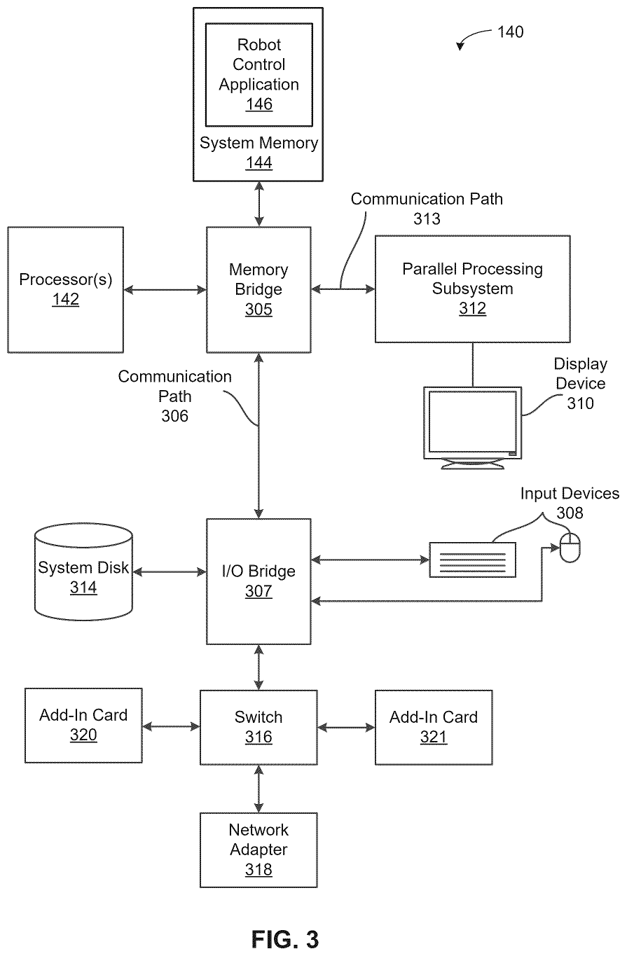

FIG. 3 is a more detailed illustration of the computing device 140 of FIG. 1, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing device 140 is a server machine operating in a data center or a cloud computing environment that provides scalable computing resources as a service over a network.

In various embodiments, the computing device 140 includes, without limitation, the processor(s) 142 and the system memory 144 coupled to a parallel processing subsystem 312 via a memory bridge 305 and a communication path 313. The memory bridge 305 is further coupled to an I/O bridge 307 via a communication path 306, and the I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, the computing device 140 may not include the input devices 308, but may receive equivalent input information by receiving commands (e.g., responsive to one or more inputs from a remote computing device) in the form of messages transmitted over a network and received via the network adapter 318. In some embodiments, the switch 316 is configured to provide connections between the I/O bridge 307 and other components of the computing device 140, such as a network adapter 318 and various add-in cards 320 and 321.

In some embodiments, the I/O bridge 307 is coupled to a system disk 314 that may be configured to store content and applications and data for use by the processor(s) 142 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to the I/O bridge 307 as well.

In various embodiments, the memory bridge 305 may be a Northbridge chip, and the I/O bridge 307 may be a Southbridge chip. In addition, the communication paths 306 and 313, as well as other communication paths within the computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more PPUs, also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 144 includes at least one device driver configured to manage the processing operations of the one or more PPUs within the parallel processing subsystem 312. In addition, the system memory 144 includes the robot control application 146. Although described herein primarily with respect to the robot control application 146, techniques disclosed herein can also be implemented, either entirely or in part, in other software and/or hardware, such as in the parallel processing subsystem 312.

In various embodiments, the parallel processing subsystem 312 may be integrated with one or more of the other elements of FIG. 3 to form a single system. For example, the parallel processing subsystem 312 may be integrated with the processor(s) 142 and other connection circuitry on a single chip to form a SoC.

In some embodiments, the processor(s) 142 includes the primary processor of the computing device 140, controlling and coordinating operations of other system components. In some embodiments, the processor(s) 142 issue commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 312, may be modified as desired. For example, in some embodiments, the system memory 144 could be connected to the processor(s) 142 directly rather than through the memory bridge 305, and other devices may communicate with the system memory 144 via the memory bridge 305 and the processor(s) 142. In other embodiments, the parallel processing subsystem 312 may be connected to the I/O bridge 307 or directly to the processor(s) 142, rather than to the memory bridge 305. In still other embodiments, the I/O bridge 307 and the memory bridge 305 may be integrated into a single chip instead of existing as one or more discrete devices. In certain embodiments, one or more components shown in FIG. 3 may not be present. For example, the switch 316 could be eliminated, and the network adapter 318 and the add-in cards 320, 321 would connect directly to the I/O bridge 307. Lastly, in certain embodiments, one or more components shown in FIG. 3 may be implemented as virtualized resources in a virtual computing environment, such as a cloud computing environment. For example, the parallel processing subsystem 312 may be implemented as a virtualized parallel processing subsystem in at least one embodiment. As a specific example, the parallel processing subsystem 312 may be implemented as virtual graphics processing unit(s) (vGPU(s)) that render graphics on a virtual machine(s) (VM(s)) executing on server machine(s) whose GPU(s) and other physical resources are shared across one or more VMs.

### Robot Control Models Trained Using Semantically Aligned Generative Augmentation

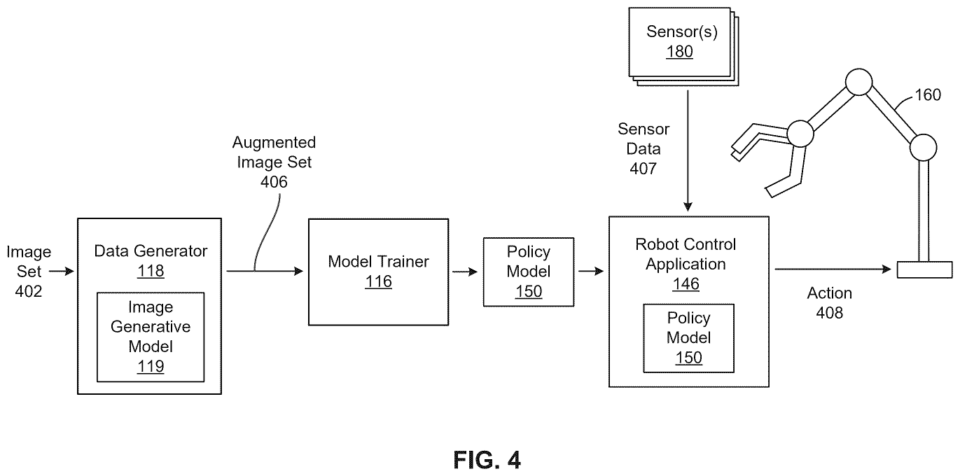

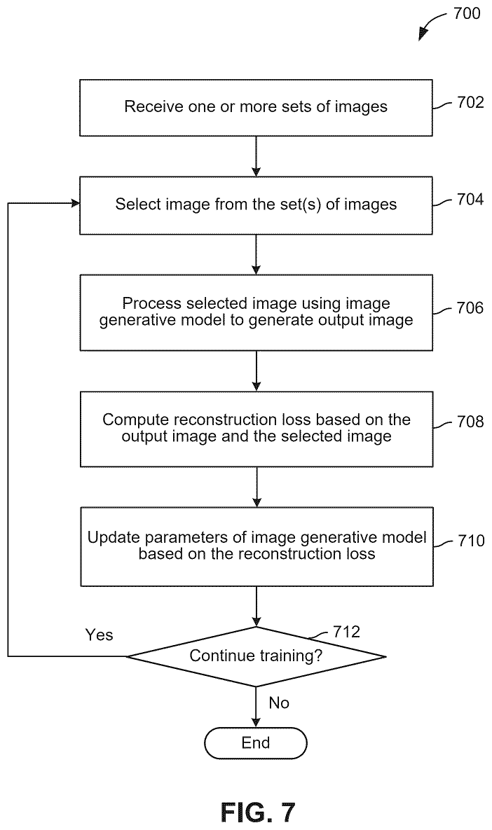

FIG. 4 illustrates how a policy model can be trained to control a robot, according to various embodiments. As shown, the data generator 118 includes, without limitation, the image generative model 119. The image generative model 119 is a trained machine learning model that is configured to take as input an image and text describing a robot task associated with the image and an augmentation to apply to the image, and to output an augmented image. Details of the image generative model 119, as well as techniques for training the image generative model 119, are discussed in greater detail below in conjunction with FIGS. 5 and 7.

In operation, the data generator 118 can receive a set of images, shown as image set 402, that includes images associated with one or more robot tasks that are captured by one or more cameras. The camera(s) can include one or more physical cameras, such as cameras included in the sensors 180 associated with the robot 160, that capture images of real-world environments and/or one or more virtual cameras that capture images within simulated environments, which can be virtual environments that simulate real-world environments. In some embodiments, the image set 402 can include sets of images from different domains, such as real-world images and images of simulations in different simulation environments.

The data generator 118 processes the image set 402 using the image generative model 119 to generate augmented images. The augmented images include the same objects as images from the image set 402, but the augmented images have different colors, lighting conditions, and/or textures and can be in different domains, such as real images or simulation images, depending on the text used to generate the augmented images. For example, in some embodiments, the data generator 118 can repeatedly input, into the image generative model 119, an image from the image set 402 along with text describing the associated robot task and an augmentation to apply to the image. In such cases, the text can describe the augmentation in any suitable manner, including with any level of specificity. For example, the augmentation could be described generally as transforming the image into another image from a simulated or real-world environment. As another example, the augmentation could be described as transforming the image into another image from a specific domain, such as a specific simulated environment. Similarly, the text can describe the robot task in any suitable manner, including with any level of specificity. For example, the task could be described generally as a robot in a kitchen. As another example, the task could be described more specifically as a robot picking up an object in a kitchen. In some embodiments, the text describing the robot task and augmentations to be applied can be generated using one or more templates, or in any other technically feasible manner.

As discussed in greater detail below, the image generative model 119 is configured to extract render invariant features, including depth information and semantic information about different identities of objects (e.g., whether an object is an apple, a bottle, etc.), from images that are input into the image generative model 119, and the image generative model 119 generates the augmented images conditioned on the render invariant features. Although described herein primarily with respect to depth and semantic information as reference examples of invariant features, any technically feasible invariant features can be extracted using computer vision techniques in some embodiments, such as surface normals, segmentations, etc. The augmented images will include the same render invariant features, such as the same identities of objects and the same depths, as the input images. Once generated, the augmented images are included, along with the image set 402, in an augmented image set 406 that is output by the data generator 118. The augmented image set 406 can be stored in the data store 120 or elsewhere.

The model trainer 116 trains a policy model, shown as the policy model 150, to control a robot, shown as the robot 160, using the augmented image set 406. The policy model 150 is a machine learning model that is trained, using the augmented image set 406, to generate actions for controlling a robot to perform at least part of a task. Although described herein primarily with respect to a policy model as a reference example, any technically feasible machine learning model can be trained using an augmented image set in some embodiments. The policy model 150 can have any suitable architecture and be trained in any technically feasible manner. For example, in some embodiments, the image set 402 can include images from expert demonstrations of tasks the policy model 150 should learn to control the robot 160 to perform. In such cases, the data generator 118 can augment the images from expert demonstrations to generated augmented image set 406, and the model trainer 116 can train the policy model 150 using a behavior cloning technique to mimic expert actions from the expert demonstrations that correspond to images from the augmented image set 406 that are input into the policy model 150. In such cases, the policy model 150 can be trained, using supervised learning, to predict actions that mimic the expert actions based on observed states that include the images from the augmented image set 406, and the training can minimize a behavior cloning loss that is a difference between predicted actions and expert actions. Because the augmented image set 406 includes relatively diverse images having different diverse colors, textures, lighting conditions, etc., the trained policy model 150 can better generalize to correctly control a robot in different scenarios.

Once trained, the policy model 150 can be deployed to control a robot in a physical or virtual environment. Illustratively, the policy model 150 has been deployed in the robot control application 146 to control the robot 160 based on sensor data 407 that is received from the sensors 180. The sensor data 407 can include images captured by one or more cameras mounted on the robot 160 and/or within the environment. Given the sensor data 407 as input, the policy model 150 generates an action 408 that represents a command for controlling the robot 160 to perform at least part of a task. In some embodiments, the robot control application 146 can transmit the action 408 to a low-level controller, such as a proportional integral derivative (PID) controller or a proportional derivative (PD) controller, that controls actuators of the robot 160 according to the action 408.

FIG. 5 is a more detailed illustration of the image generative model 119 of FIG. 1, according to various embodiments. As shown, the image generative model 119 includes, without limitation, an activation function 506, a diffusion module 508, a depth feature extractor 510, downsample and zero convolution layers 512, a semantic feature extractor 518, upsample and zero convolution layers 520, diffusion module copies 514 and 522, zero convolution layers 516 and 524, an activation function 526, and a decoder 528.

Image generative model 119 is a machine learning model, such as an artificial neural network. In operation, image generative model 119 takes as input an image 502 and text 504 describing a robot task associated with the image 502 and an augmentation to apply to the image. Similar to the description above in conjunction with FIG. 4, the text 504 can describe the robot task and the augmentation in any suitable manner, including with any level of specificity, in some embodiments.

Using the image 502 and the text 504, the image generative model 119 generates an image 530 that applies that augmentation specified by the text 504. Illustratively, the following processing is performed in parallel: (1) the image 502 and the text 504 are processed using the activation function 506 to generate features, and the diffusion module 508 performs a denoising diffusion technique conditioned on the generated features to generate a first feature map; (2) the image 502 is processed using the depth feature extractor 510, which is a computer vision module that extracts features indicating the depths of objects in the image 502, the extracted features are further processed using down sample and zero convolution layers 512 to generate additional features that are concatenated with text features generated by the activation function 506, and the diffusion module copy 514 performs a denoising diffusion technique conditioned on the concatenated features to generate an intermediate feature map, which is further processed by the zero convolution layer 516 to generate a second feature map; and (3) the image 502 is processed using the semantic feature extractor 518, which is a computer vision module that extracts features indicating semantic information about the identities of objects in the image 502, the extracted features are further processed using up sample and zero convolution layers 520 to generate additional features that are concatenated with text features generated by the activation function 506, and the diffusion module copy 522 performs a denoising diffusion technique conditioned on the concatenated features to generate an intermediate feature map, which is further processed using the zero convolution layer 524 to generate a third feature map. The first, second, and third feature maps are then concatenated and processed using the activation function 526 to generate additional features that the decoder 528 decodes to generate the image 530.

In some embodiments, the diffusion module 508 can include a pre-trained text-to-image diffusion model, such as the Stable Diffusion XL model. The underlying mechanism of such a model is based on denoising diffusion probabilistic models (DDPM), which defines a forward diffusion process that gradually adds Gaussian noise to images, and a reverse process that learns to denoise random noise into images. Specifically, the forward process can be defined as:

$$q ( {x}_{t} \vert {x}_{t - 1} ) = 𝒩 ( {x}_{t} ; \sqrt{1 - {β}_{t}} {x}_{t - 1} , {β}_{t} I ) , \qquad ( 1 )$$

where βₜ is the noise schedule, and xₜ represents the image at timestep t. The reverse process learns to predict the noise ϵ_{θ} and can be optimized using:

$$ℒ = {𝔼}_{{x}_{0 ,} ϵ , t} [ {‖ ϵ - {ϵ}_{θ} ( {x}_{t} , t ) ‖}^{2} ] , \qquad ( 2 )$$

which makes the reverse diffusion process a Gaussian distribution:

$${p}_{θ} ( {x}_{t - 1} \vert {x}_{t} , c ) = 𝒩 ( {x}_{t - 1} ; {μ}_{θ} ( {x}_{t} , t , c ) , {\sum }_{θ} ( {x}_{t} , t ) ) . \qquad ( 3 )$$

To enable text-guided generation, the diffusion module 508 can incorporate text conditioning through classifier-free guidance. During inference, the noise prediction is guided by:

$$\hat{ϵ} = {ϵ}_{θ} ( {x}_{t} , c ) + w ( {ϵ}_{θ} ( {x}_{t} , c ) - {ϵ}_{θ} ( {x}_{t} , ∅ ) ) , \qquad ( 4 )$$

where c is the text condition, Ø represents unconditional generation, and w is the guidance scale that controls the alignment strength between the generated image and the text prompt.

While DDPM models excel at generating diverse images from text prompts, maintaining precise spatial control over the generated content remains challenging. In some embodiments, to address this limitation, ControlNet can be used to enable fine-grained spatial control while preserving the generative capabilities of the base diffusion model. ControlNet extends traditional diffusion models by introducing additional conditioning pathways for control signals. In particular, ControlNet can be used to allow conditioning based on depth features generated using the depth feature extractor 510 and semantic features generated using the semantic feature extractor 518. Although described herein primarily with respect to ControlNet as a reference example, in some embodiments, any technically feasible mechanism that permits denoising diffusion to be conditioned on depth and semantic features can be used.

The depth feature extractor 510 provides spatial control to help ensure that the generated image 530 includes objects with the same geometry and at the same depths as objects in the image 502. In some embodiments, the depth feature extractor 510 can be implemented using any technically feasible machine learning model that is able to extract depth information from an input image, such as a Depth-Anything-v2 model that serves as a foundation model for extracting precise depth information from input images. In some embodiments, the backbone of both the original diffusion model and ControlNet in the diffusion module copy 514 can be a UNet architecture, which processes features at multiple resolutions through encoder-decoder pathways with skip connections. In such cases, the depth conditioning can be incorporated into the diffusion process through a modified UNet architecture:

$${ϵ}_{θ} ( {x}_{t} , t , c , h ) = UNet ( {x}_{t} , t , c ) + ZeroConv ( Control ( ZeroConv ( h ) ) ) , \qquad ( 5 )$$

where h represents the depth condition extracted by the depth feature extractor 510 (e.g., Depth-Anything-v2). The control module in the diffusion module copy 514 mirrors the UNet architecture but processes only the depth information. The zero convolution layers in the downsample and zero convolution layers 512 and the zero convolution layer 516 are initialized with zeros and serve two purposes: the zero convolution layers allow gradual learning of the control signal during training and prevent the depth conditioning from overwhelming the original generation process. Consequently, the depth-conditioned generation process can be formulated as:

$${p}_{θ} ( {x}_{t - 1} \vert {x}_{t} , c , h ) = 𝒩 ( {x}_{t - 1} ; {μ}_{θ} ( {x}_{t} , t , c , h ) , {\sum }_{θ} ( {x}_{t} , t ) ) , \qquad ( 6 )$$

where μ_{θ} computes the denoised image mean using the depth-aware noise prediction. In some embodiments, the control modules and zero convolution layers can be trained while keeping the original UNet weights frozen, maintaining the generative capabilities of the base model while adding spatial control.

The semantic feature extractor 518 provides geometric control to help ensure that the generated image 530 includes the same identities of objects as the image 502. In some embodiments, the semantic feature extractor 518 can be implemented using any technically feasible machine learning model, such as the SigLIP (Sigmoid Loss Image Pretraining) model, that is able to associate text labels with an input image. Similar to the depth conditioning pathway, the semantic feature extractor 518 can process the semantic features through zero convolution layers:

$${ϵ}_{θ} ( {x}_{t} , t , c , h , s ) = Unet ( {x}_{t} , t , c ) + ZeroConv ( {Contro1}_{depth} ( ZeroConv ( h ) ) ) + ZeroConv ( {Control}_{s e m} ( ZeroConv ( s ) ) ) , \qquad ( 7 )$$

where s represents the semantic features extracted by the semantic feature extractor 518 (e.g., SigLIP). The semantic control branch transforms the token-based features into spatial representations that align with the image generation process. When SigLIP in particular is used as the semantic feature extractor 518, in order to accommodate the semantic conditioning mechanism differing from the geometry branch due to the token-based nature of the representations of SigLIP, the control architecture can be modified to use upsample modules, as shown in the upsample and zero convolution layers 520. Experience has shown that semantic extractors such as SigLIP provide superior semantic alignment when a language-contrastive learning approach is used to train the semantic extractors to better captures semantic relationships between text and visual features, i.e., the language-vision alignment inherent in training can help maintain semantic consistency in the image generative model 119.

As described, a feature map is generated by each of the diffusion module 508, the diffusion module copy 514 that is conditioned on depth features extracted by the depth feature extractor 510, and the diffusion module copy 522 that is conditioned on semantic features extracted by the semantic feature extractor 518. The generated feature maps are then processed using the activation function 526 to generate additional features that the decoder 528 decodes to generate the image 530. The decoder 528 can be implemented in any technically feasible manner, such as with one or more neural network layers (e.g., the neural network layers of the decoders from a stable diffusion model).

In some embodiments, the image generative model 119 can be trained using images from different image data sets, such as image data sets associated with physical and/or simulated environments and/or data sets associated with different domains. Any technically feasible training techniques, such as backpropagation with gradient descent or a variation thereof, can be used to train the image generative model 119 in some embodiments. In some embodiments, training of the image generative model 119 can minimize a reconstruction loss that is a difference between an input image and an image generated by the image generative model 119. The reconstruction loss can be used when the training data does not include paired images that include examples of output images having different augmentations, so the goal of training will instead be to reconstruct the input images. In some embodiments, early termination of the training can be used to introduce variance (i.e., randomness) into outputs of the image generative model 119. In some embodiments, certain parameters of the image generative model 119 can remain fixed, while other parameters of the image generative model 119 are updated, during training. Returning to the example in which the diffusion module copy 514 and the diffusion module copy 522 each include a diffusion model with ControlNet, the training can include updating parameters of the ControlNet while keeping the diffusion model fixed. Further, in some embodiments, parameters of a diffusion module in the diffusion module 508 can remain fixed during training. In addition, parameters of the depth feature extractor 510 and the semantic feature extractor 518 can remain fixed during training in some embodiments.

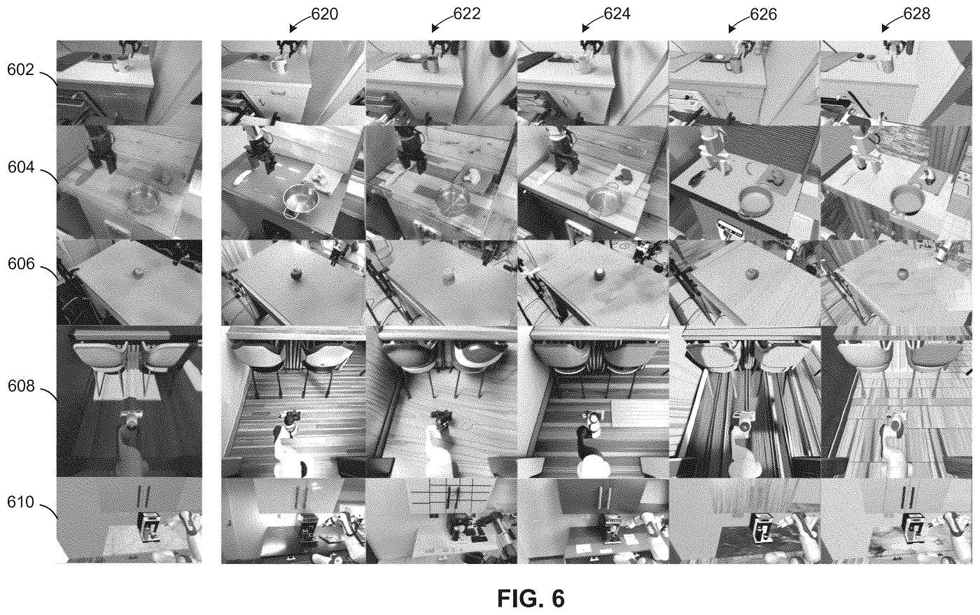

FIG. 6 illustrates exemplar input and output images of the image generative model 119 of FIG. 1, according to various embodiments. As shown, input images 602 and 604 are from two different real-world datasets, and images 606, 608, and 610 are from three different simulated datasets. Given as input an image 602, 604, 606, 608, or 610 and text specifying converting the input image to a domain of the real-world data set associated with the input image 602, the image generative model 119 can generate images 620. Given as input an image 602, 604, 606, 608, or 610 and text specifying converting the input image to a domain of the real-world data set associated with the input image 604, the image generative model 119 can generate images 622. Given as input an image 602, 604, 606, 608, or 610 and text specifying converting the input image to a domain of the simulated data set associated with the input image 606, the image generative model 119 can generate images 624. Given as input an image 602, 604, 606, 608, or 610 and text specifying converting the input image to a domain of the simulated data set associated with the input image 608, the image generative model 119 can generate images 626. Given as input an image 602, 604, 606, 608, or 610 and text specifying converting the input image to a domain of the simulated data set associated with the input image 610, the image generative model 119 can generate images 628.

FIG. 7 is a flow diagram of method steps for training the image generative model 119, according to various embodiments. Although the method steps are described in conjunction with the systems of FIGS. 1-5, persons skilled in the art will understand that any system configured to perform the method steps in any order falls within the scope of the present embodiments.

As shown, a method 700 begins at step 702, where the model trainer 116 receives one or more sets of images. As described, in some embodiments, the image generative model 119 can be trained using images from different image data sets, such as image data sets associated with physical and/or simulated environments and/or data sets associated with different domains

At step 704, the model trainer 116 selects an image from the set(s) of images. Then, at step 706, the model trainer 116 processes the selected image using an untrained version of the image generative model 119 to generate an output image. The image generative model 119 is described above in conjunction with FIG. 5.

At step 708, the model trainer 116 computes a reconstruction loss based on the output image and the selected image. The reconstruction loss is a difference (e.g., a pixel-wise difference) between the selected image and the output image that is generated by the image generative model 119. As described, a reconstruction loss can be used in some embodiments when the training data does not include paired images that include examples of output images having different augmentations, so the goal of training will instead be to reconstruct the input images.

At step 710, the model trainer 116 updates parameters of the image generative model 119 based on the reconstruction loss. As described, in some embodiments, parameters of the image generative model 119 can be iteratively updated in any technically feasible manner, such as via backpropagation with gradient descent or a variation thereof. In some embodiments, certain parameters of the image generative model 119 can remain fixed, while other parameters of the image generative model 119 are updated, during training. For example, when the diffusion module copy 514 and the diffusion module copy 522 each include a diffusion model with ControlNet, parameters of the ControlNet can be updated during training, while parameters of the diffusion model remain fixed. Further, in some embodiments, parameters of a diffusion module in the diffusion module 508 can remain fixed during training. In addition, parameters of the depth feature extractor 510 and the semantic feature extractor 518 can remain fixed during training in some embodiments.

At step 712, if the model trainer 116 determines to continue training, then the method 700 returns to step 704, where the model trainer 116 selects another image from the set(s) of images. In some embodiments, the model trainer 116 can iteratively update parameters of the vision encoder based on the reconstruction loss until a stopping condition is met, such as training has been performed for a predefined number of iterations, the loss plateaus, or the like. In some embodiments, early termination of the training can be used to introduce variance (i.e., randomness) into outputs of the image generative model 119.

On the other hand, if the model trainer 116 determines to stop training at step 712, then the method 700 ends.

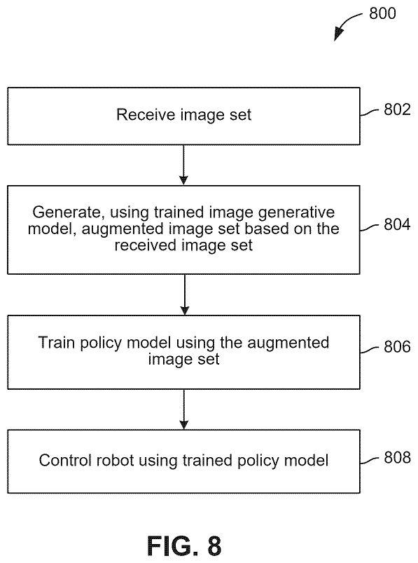

FIG. 8 is a flow diagram of method steps for controlling a robot, according to various embodiments. Although the method steps are described in conjunction with the systems of FIGS. 1-6, persons skilled in the art will understand that any system configured to perform the method steps in any order falls within the scope of the present embodiments.

As shown, a method 800 begins at step 802, where the data generator 118 receives a set of images. In some embodiments, the set of images can include one or more image data sets that include or are associated with a robot, such as images captured by cameras mounted on the robot or elsewhere within different physical and/or simulated environments.

At step 804, the data generator 118 generates, using the trained image generative model 119, an augmented image set based on the received set of images. As described above in conjunction with FIG. 4, in some embodiments, the data generator 118 can repeatedly input, into the image generative model 119, an image from the set of images along with text describing an associated robot task and an augmentation to apply to the image. The text can describe the augmentation and the robot task in any suitable manner, including with any level of specificity. In some embodiments, the text can be generated using one or more templates, or in any other technically feasible manner. Given the image and the text, the image generative model 119 generates an augmented image that can be included in the augmented image set.

At step 806, the model trainer 116 (or another model training application) trains the policy model 150 using the augmented image set. The policy model 150 can be trained in any technically feasible manner in some embodiments, such as using a behavior cloning technique, as described above in conjunction with FIG. 4.

At step 808, the robot control application 146 controls a robot (e.g., robot 160) using the trained policy model. As described, in some embodiments, the robot control application 146 can control the robot 160 based on sensor data that is received from the sensors 180. The sensor data can include images captured by one or more cameras mounted on the robot 160 and/or within the environment. Given the sensor data as input, the policy model 150 generates an action that represents a command for controlling the robot 160 to perform at least part of a task. In some embodiments, the robot control application 146 can transmit the action to a low-level controller, such as a PID controller or a PD controller, that controls actuators of the robot 160 according to the action.

In sum, techniques are disclosed for generating augmented image data and training machine learning models using the augmented image data. In some embodiments, a trained image generative model takes as input images and text describing augmentations, and the image generative model generates augmented images conditioned on the input images, depth and semantic features extracted from the input images, and the text describing augmentations. The image generative model includes three diffusion modules. For a given image input image and text, a first diffusion module is used to generate a feature map conditioned on the input image and the text. A second diffusion module is used to generate a second feature map conditioned on the image, depth features extracted from the image, and the text. A third diffusion module is used to generate a third feature map conditioned on the image, semantic features extracted from the image, and the text. A decoder processes the first, second, and third feature maps to generate an augmented image. Any number of augmented images can be generated according to the foregoing steps for inclusion in a training data set. Then, a machine learning model, such as a policy model for controlling a robot, can be trained using the training data set. Once trained, the machine learning model can be deployed to perform one or more tasks. For example, a trained policy model could be deployed to control a robot within a real or virtual environment.

At least one technical advantage of the disclosed techniques relative to the prior art is that the disclosed techniques generate augmented images that can provide diverse data sets for training machine learning models, such as policy models for controlling robots. Using augmented images generated according to the disclosed techniques, a policy model can be trained to control a robot to perform a task more successfully than policy models that are trained using conventional approaches. In particular, the augmented images preserve depth and semantic information from input images, which are useful for training a policy model to correctly perform tasks. These technical advantages represent one or more technological improvements over prior art approaches.

1. In some embodiments, a computer-implemented method for training machine learning models comprises processing one or more input images using a trained image generative model to generate one or more augmented images, wherein the trained image generative model generates each augmented image included in the one or more augmented images conditioned on an input image included in the one or more input images, depth information associated with the input image, semantic information associated with the input image, and text describing an augmentation to make to the input image, and performing, based on the one or more augmented images, one or more operations to train an untrained machine learning model to generate a trained machine learning model.

2. The computer-implemented method of clause 1, wherein the trained image generative model comprises a first trained machine learning model that extracts the depth information from the input image, and a second trained machine learning model that extracts the semantic information from the input image.

3. The computer-implemented method of clauses 1 or 2, wherein generating each augmented image included in the one or more augmented images conditioned on the input image included in the one or more input images comprises generating, using a first trained diffusion model conditioned on the input image and the text, a first feature map, generating, using a second trained diffusion model conditioned on the input image, the depth information associated with the input image, and the text, a second feature map, generating, using a third trained diffusion model conditioned on the input image, the semantic information associated with the input image, and the text, a third feature map, and generating the augmented image based on the first feature map, the second feature map, and the third feature map.

4. The computer-implemented method of any of clauses 1-3, wherein generating the augmented image comprises processing the first feature map, the second feature map, and the third feature map using at least a decoder to generate the augmented image.

5. The computer-implemented method of any of clauses 1-4, wherein the one or more input images include a plurality of sets of images from at least one of one or more real-world environments or one or more simulated environments.

6. The computer-implemented method of any of clauses 1-5, wherein the text describes at least one of a robotic task, a physical environment, a virtual environment, or a domain.

7. The computer-implemented method of any of clauses 1-6, wherein the one or more operations to train the untrained machine learning model include training the untrained machine learning model using the one or more input images.

8. The computer-implemented method of any of clauses 1-7, wherein the trained machine learning model is trained to generate actions for controlling a robot to perform at least one task.

9. The computer-implemented method of any of clauses 1-8, wherein the trained machine learning model is trained to process one or more additional images to generate one or more actions that cause a robot to move.

10. The computer-implemented method of any of clauses 1-9, further comprising performing, based on one or more additional images and a reconstruction loss, one or more training operations to train an image generative model to generate the trained image generative model.

11. In some embodiments, one or more non-transitory computer-readable media store instructions that, when executed by at least one processor, cause the at least one processor to perform the steps of processing one or more input images using a trained image generative model to generate one or more augmented images, wherein the trained image generative model generates each augmented image included in the one or more augmented images conditioned on an input image included in the one or more input images, depth information associated with the input image, semantic information associated with the input image, and text describing an augmentation to make to the input image, and performing, based on the one or more augmented images, one or more operations to train an untrained machine learning model to generate a trained machine learning model.

12. The one or more non-transitory computer-readable media of clause 11, wherein the trained image generative model comprises a first trained machine learning model that extracts the depth information from the input image, and a second trained machine learning model that extracts the semantic information from the input image.

13. The one or more non-transitory computer-readable media of clauses 11 or 12, wherein generating each augmented image included in the one or more augmented images conditioned on the input image included in the one or more input images comprises generating, using a first trained diffusion model conditioned on the input image and the text, a first feature map, generating, using a second trained diffusion model conditioned on the input image, the depth information associated with the input image, and the text, a second feature map, generating, using a third trained diffusion model conditioned on the input image, the semantic information associated with the input image, and the text, a third feature map, and generating the augmented image based on the first feature map, the second feature map, and the third feature map.

14. The one or more non-transitory computer-readable media of any of clauses 11-13, wherein at least one of the first trained diffusion model, the second trained diffusion model, or the third trained diffusion model comprises a ControlNet model.

15. The one or more non-transitory computer-readable media of any of clauses 11-14, wherein the text describes at least one of a robotic task, a physical environment, a virtual environment, or a domain.

16. The one or more non-transitory computer-readable media of any of clauses 11-15, wherein the trained machine learning model is trained to generate actions for controlling a robot to perform at least one task.

17. The one or more non-transitory computer-readable media of any of clauses 11-16, wherein the trained machine learning model is trained to process one or more additional images to generate one or more actions that cause a robot to move.

18. The one or more non-transitory computer-readable media of any of clauses 11-17, wherein the one or more operations to train the untrained machine learning model include training the untrained machine learning model using a behavior cloning loss.

19. The one or more non-transitory computer-readable media of any of clauses 11-18, wherein the semantic information identifies at least one object included in the input image.

20. In some embodiments, a system comprises a memory storing instructions, and one or more processors, that when executing the instructions, are configured to perform the steps of processing one or more input images using a trained image generative model to generate one or more augmented images, wherein the trained image generative model generates each augmented image included in the one or more augmented images conditioned on an input image included in the one or more input images, depth information associated with the input image, semantic information associated with the input image, and text describing an augmentation to make to the input image, and performing, based on the one or more augmented images, one or more operations to train an untrained machine learning model to generate a trained machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

We claim:

1. A computer-implemented method for training machine learning models, the method comprising:
processing one or more input images using a trained image generative model to generate one or more augmented images, wherein the trained image generative model generates each augmented image included in the one or more augmented images conditioned on an input image included in the one or more input images, depth information associated with the input image, semantic information associated with the input image, and text describing an augmentation to make to the input image; and
performing, based on the one or more augmented images, one or more operations to train an untrained machine learning model to generate a trained machine learning model.

2. The computer-implemented method of claim 1, wherein the trained image generative model comprises:
a first trained machine learning model that extracts the depth information from the input image; and
a second trained machine learning model that extracts the semantic information from the input image.

3. The computer-implemented method of claim 1, wherein generating each augmented image included in the one or more augmented images conditioned on the input image included in the one or more input images comprises:
generating, using a first trained diffusion model conditioned on the input image and the text, a first feature map;
generating, using a second trained diffusion model conditioned on the input image, the depth information associated with the input image, and the text, a second feature map;
generating, using a third trained diffusion model conditioned on the input image, the semantic information associated with the input image, and the text, a third feature map; and
generating the augmented image based on the first feature map, the second feature map, and the third feature map.

4. The computer-implemented method of claim 3, wherein generating the augmented image comprises processing the first feature map, the second feature map, and the third feature map using at least a decoder to generate the augmented image.

5. The computer-implemented method of claim 1, wherein the one or more input images include a plurality of sets of images from at least one of one or more real-world environments or one or more simulated environments.

6. The computer-implemented method of claim 1, wherein the text describes at least one of a robotic task, a physical environment, a virtual environment, or a domain.

7. The computer-implemented method of claim 1, wherein the one or more operations to train the untrained machine learning model include training the untrained machine learning model using the one or more input images.

8. The computer-implemented method of claim 1, wherein the trained machine learning model is trained to generate actions for controlling a robot to perform at least one task.

9. The computer-implemented method of claim 1, wherein the trained machine learning model is trained to process one or more additional images to generate one or more actions that cause a robot to move.

10. The computer-implemented method of claim 1, further comprising performing, based on one or more additional images and a reconstruction loss, one or more training operations to train an image generative model to generate the trained image generative model.

11. One or more non-transitory computer-readable media storing instructions that, when executed by at least one processor, cause the at least one processor to perform the steps of:
processing one or more input images using a trained image generative model to generate one or more augmented images, wherein the trained image generative model generates each augmented image included in the one or more augmented images conditioned on an input image included in the one or more input images, depth information associated with the input image, semantic information associated with the input image, and text describing an augmentation to make to the input image; and
performing, based on the one or more augmented images, one or more operations to train an untrained machine learning model to generate a trained machine learning model.

12. The one or more non-transitory computer-readable media of claim 11, wherein the trained image generative model comprises:
a first trained machine learning model that extracts the depth information from the input image; and
a second trained machine learning model that extracts the semantic information from the input image.

13. The one or more non-transitory computer-readable media of claim 11, wherein generating each augmented image included in the one or more augmented images conditioned on the input image included in the one or more input images comprises:
generating, using a first trained diffusion model conditioned on the input image and the text, a first feature map;
generating, using a second trained diffusion model conditioned on the input image, the depth information associated with the input image, and the text, a second feature map;
generating, using a third trained diffusion model conditioned on the input image, the semantic information associated with the input image, and the text, a third feature map; and
generating the augmented image based on the first feature map, the second feature map, and the third feature map.

14. The one or more non-transitory computer-readable media of claim 13, wherein at least one of the first trained diffusion model, the second trained diffusion model, or the third trained diffusion model comprises a ControlNet model.

15. The one or more non-transitory computer-readable media of claim 11, wherein the text describes at least one of a robotic task, a physical environment, a virtual environment, or a domain.

16. The one or more non-transitory computer-readable media of claim 11, wherein the trained machine learning model is trained to generate actions for controlling a robot to perform at least one task.

17. The one or more non-transitory computer-readable media of claim 11, wherein the trained machine learning model is trained to process one or more additional images to generate one or more actions that cause a robot to move.

18. The one or more non-transitory computer-readable media of claim 11, wherein the one or more operations to train the untrained machine learning model include training the untrained machine learning model using a behavior cloning loss.

19. The one or more non-transitory computer-readable media of claim 11, wherein the semantic information identifies at least one object included in the input image.

20. A system, comprising:
a memory storing instructions; and
one or more processors, that when executing the instructions, are configured to perform the steps of:
processing one or more input images using a trained image generative model to generate one or more augmented images, wherein the trained image generative model generates each augmented image included in the one or more augmented images conditioned on an input image included in the one or more input images, depth information associated with the input image, semantic information associated with the input image, and text describing an augmentation to make to the input image, and
performing, based on the one or more augmented images, one or more operations to train an untrained machine learning model to generate a trained machine learning model.
